(19) United States
(12) Patent Application Publication
(10) Pub. No.: US 2025/0198248 A1
(43) Pub. Date: Jun. 19, 2025

(54) METHODS AND APPARATUSES FOR REMOVING METAL OBJECTS FROM WELLS

(71) Applicant: ExxonMobil Technology and Engineering Company, Spring, TX (US)

(72) Inventors: James B. THOMAS, Aledo, TX (US); Tom T. LAI, Midland, TX (US)

(21) Appl. No.: 18/948,115

(22) Filed: Nov. 14, 2024

Related U.S. Application Data
(60) Provisional application No. 63/610,580, filed on Dec. 15, 2023.

(51) Int. Cl. E21B 31/00; B23K 11/11; E21B 31/18

(52) U.S. Cl. CPC E21B 31/007; B23K 11/11; E21B 31/18

(57) ABSTRACT

An apparatus and method for retrieving metal objects from wellbores are provided. An exemplary apparatus includes a fishing tool that has a metal welding surface. The apparatus also includes an electrode coupled to the metal welding surface and a power source. An exemplary method includes lowering a weld-based fishing tool into a wellbore of a well. The method includes initiating a welding to bond a weld-based fishing tool with a fish. The method includes raising the weld-based fishing tool from the wellbore to retrieve the fish.

### CROSS-REFERENCE TO RELATED APPLICATION

This application claims priority to and the benefit of U.S. Provisional Application No. 63/610,580, entitled “METHODS AND APPARATUSES FOR REMOVING METAL OBJECTS FROM WELLS,” having a filing date of Dec. 15, 2023. the disclosure of which is incorporated herein by reference in its entirety.

### FIELD OF THE INVENTION

The present application relates generally to the field of well workover and intervention, and drilling operations. Specifically, the disclosure relates to a methodology for the retrieval of metal objects from wells.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Sometimes objects such as pipes may be inadvertently dropped or left downhole in a well. In other examples, an object may have been unsuccessfully attempted to be pulled out of the well. Such objects are referred to herein as fish, and the process of retrieval referred to as fishing. Fishing tools are used to perform the fishing. Fishing tools are special mechanical devices used to aid the recovery of equipment lost downhole. These devices generally fall into four classes: diagnostic, inside grappling, outside grappling, and force intensifiers or jars. Diagnostic devices may range from a simple impression block made in a soft metal, usually lead, that is dropped rapidly onto the top of the fish so that upon inspection at the surface, the fisherman may be able to custom design a tool to facilitate attachment to and removal of the fish. Other diagnostic tools may include electronic instruments and even downhole sonic or visual-bandwidth cameras. Inside grappling devices, usually called spears, generally have a tapered and threaded profile, enabling the fisherman to first guide the tool into the top of the fish, and then thread the fishing tool into the top of the fish so that recovery may be attempted. Outside grappling devices, usually called overshots, are fitted with grapples (slip or teeth), latch dogs, or another shape that swallows a top of the fish and does not release it as it is pulled out of the hole. Overshots may also be fitted with a crude drilling surface at the bottom, so that the overshot may be lightly drilled over the fish, sometimes to remove rock or metallic junk that may be part of the sticking mechanism. Jars are mechanical downhole hammers, which enable the fisherman to deliver high-impact loads to the fish, far in excess of what could be applied in a quasi-static pull from the surface.

Typical fishing tools for catching and retrieving pipes or other objects inadvertently dropped or left in the hole include spiral and basket grapples, taper taps, and spears. For example, a spiral and basket grapple includes a spiral that acts like a grapple to attach to a fish, a bowl to house a grapple and transfer weight from the grapple. As tension is applied to the tool, the tapered design of the bowl forces the grapple into the fish. A taper tap may include a mandrel and a grapple with a tapered end that is inserted into a fish as an attachment device. A spear may include manipulable grapples on the side and may similarly be inserted into a fish as an attachment device.

### SUMMARY OF THE INVENTION

An embodiment provided herein relates to an apparatus for retrieving metal objects from wellbores. The apparatus includes a fishing tool comprising a metal welding surface. The apparatus includes an electrode coupled to the welding surface and a power source.

Another embodiment provided herein relates to an apparatus that includes a fishing tool comprising a metal welding surface. The apparatus also includes a reservoir containing a mixture of thermite and alloying metal. The apparatus further includes a welding surface coupled to the apparatus to receive molten metal from the reservoir.

Still another embodiment provided herein relates to a method for retrieving metal objects from wellbores. The method includes lowering a weld-based fishing tool into a wellbore of a well. The method includes initiating a welding to bond a weld-based fishing tool with a fish. The method also includes raising the weld-based fishing tool from the wellbore to retrieve the fish.

These and other features and attributes of the disclosed embodiments of the present

techniques and their advantageous applications and/or uses will be apparent from the detailed description that follows.

### BRIEF DESCRIPTION OF THE DRAWINGS

The present application is further described in the detailed description which follows, in reference to the noted plurality of drawings by way of non-limiting examples of exemplary embodiments, in which like reference numerals represent similar parts throughout the several views of the drawings. In this regard, the appended drawings illustrate only exemplary embodiments and are therefore not to be considered limiting of scope, for the disclosure may admit to other equally effective embodiments and applications.

To assist those of ordinary skill in the relevant art in making and using the subject matter hereof, reference is made to the appended drawings, wherein:

FIG. 1 is a cross sectional view of an exemplary apparatus using an internally grounded welding device for retrieving objects from downhole in a well;

FIG. 2 is a cross sectional view of an exemplary apparatus using a well-grounded welding device for retrieving objects from downhole in a well;

FIG. 3 is a cross sectional view of an exemplary apparatus using a thermite-based device with an overshot for retrieving objects from downhole in a well;

FIG. 4 is a cross sectional view of an exemplary apparatus using a thermite-based device with a spear with for retrieving objects from downhole in a well;

FIG. 5 is a process flow diagram of an exemplary method for retrieving a fish from a wellbore using welding;

FIG. 6 is a process flow diagram of an exemplary method for retrieving a fish from a wellbore using a welded retrieval attachment; and

FIG. 7 is a process flow diagram of an exemplary method for retrieving a fish from a wellbore using a welded retrieval attachment.

It should be noted that the figures are merely examples of the present techniques and are not intended to impose limitations on the scope of the present techniques. Further, the figures are generally not drawn to scale, but are drafted for purposes of convenience and clarity in illustrating various aspects of the techniques.

### DETAILED DESCRIPTION OF THE INVENTION

The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

It is to be understood that the present disclosure is not limited to particular devices or methods, which may, of course, vary. It is also to be understood that the terminology used herein is for the purpose of describing particular embodiments only, and is not intended to be limiting. As used herein, the singular forms “a,” “an,” and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected. The word “exemplary” is used herein to mean “serving as an example, instance, or illustration.” Any aspect described herein as “exemplary” is not necessarily to be construed as preferred or advantageous over other aspects. The term “uniform” means substantially equal for each sub-element, within about +10% variation.

The term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “including,” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the term “any” means one, some, or all of a specified entity or group of entities, indiscriminately of the quantity.

The phrase “at least one,” when used in reference to a list of one or more entities (or elements), should be understood to mean at least one entity selected from any one or more of the entities in the list of entities, but not necessarily including at least one of each and every entity specifically listed within the list of entities, and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently, “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

As used herein, the phrase “based on” does not mean “based only on,” unless expressly specified otherwise. In other words, the phrase “based on” means “based only on,” “based at least on,” and/or “based at least in part on.”

As used herein, the terms “example,” exemplary,” and “embodiment,” when used with reference to one or more components, features, structures, or methods according to the present techniques, are intended to convey that the described component, feature, structure, or method is an illustrative, non-exclusive example of components, features, structures, or methods according to the present techniques. Thus, the described component, feature, structure, or method is not intended to be limiting, required, or exclusive/exhaustive; and other components, features, structures, or methods, including structurally and/or functionally similar and/or equivalent components, features, structures, or methods, are also within the scope of the present techniques.

As used herein, the term “fish” refers to anything left in a wellbore. For example, a fish may include junk metal, a hand tool, a length of drillpipe or drill collars, or an expensive measurements-while-drilling (MWD) and directional drilling package. Once a component is lost, the lost component may be referred to as simply “the fish.” Typically, anything put into the hole is accurately measured and sketched, so that appropriate fishing tools can be selected if the item is to be fished out of the hole.

As used herein, the term “fishing” refers to the application of tools, equipment and techniques for the removal of junk, debris, or fish from a wellbore. The key elements of a fishing operation include an understanding of the dimensions and nature of the fish to be removed, the wellbore conditions, the tools and techniques employed and the process by which the recovered fish will be handled at the surface.

As used herein, the term “grapple” refers to a generic name given to tools that engage on the outer surface of a tubing string or tool assembly, generally for fishing purposes.

As used herein, the term “overshot” refers to a downhole tool used in fishing operations to engage on the outside surface of a tube or tool. A grapple, or similar slip mechanism, on the overshot grips the fish, allowing application of tensile force and jarring action. If the fish cannot be removed, a release system within the overshot allows the overshot to be disengaged and retrieved.

Generally speaking, the term “pressure” refers to a force acting on a unit area. Pressure is typically provided in units of pounds per square inch (psi).

The term “substantially,” when used in reference to a quantity or amount of a material, or a specific characteristic thereof, refers to an amount that is sufficient to provide an effect that the material or characteristic was intended to provide. The exact degree of deviation allowable may depend, in some cases, on the specific context.

As used herein, the term wellbore refers to the drilled hole or borehole, including the openhole or uncased portion of a well. Borehole may refer to the inside diameter of the wellbore wall, the rock face that bounds the drilled hole.

As used herein, “workover” refers to the repair or stimulation of an existing production well for the purpose of restoring, prolonging or enhancing the production of hydrocarbons.

If there is any conflict in the usages of a word or term in this specification and one or more patent or other documents that may be incorporated herein by reference, the definitions that are consistent with this specification should be adopted for the purposes of understanding this disclosure.

### Overview

Fishing may be performed to remove unwanted objects inside a wellbore of a well. Again, typical fishing tools for catching and retrieving pipes or other objects inadvertently dropped or left in the hole include spiral and basket grapples, taper taps, and spears, among other devices. However, the success of these tools depends on their ability to engage with the fish by going over or inside the fish. In various examples, pipe conditions, damage to the object, poor cuts, among other potential issues can cause complications with engaging the fish. For example, such complications can cause a grapple, tap, or spear may slip off or out of the fish.

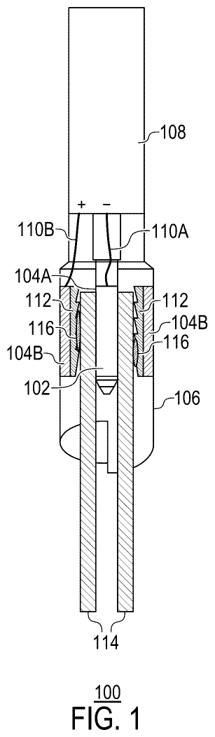

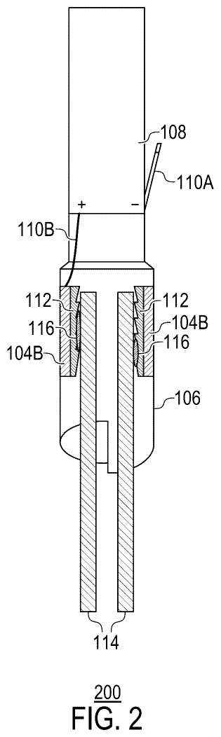

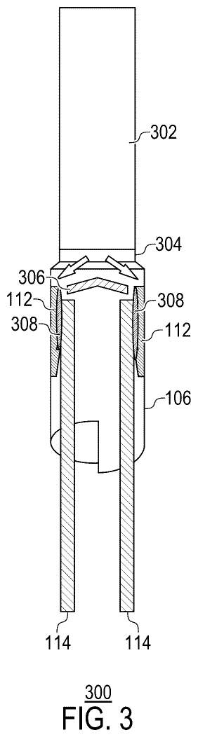

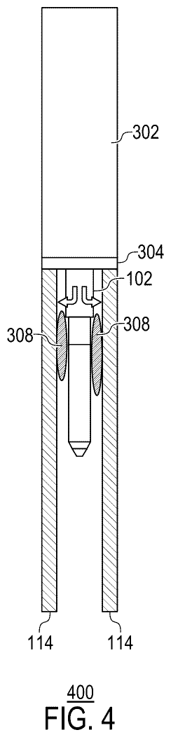

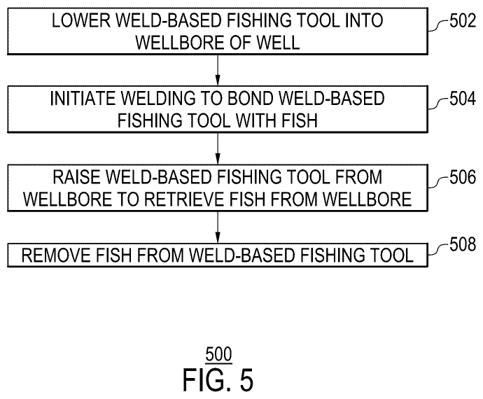

Accordingly, the present techniques solve these problems by providing a means of retrieving objects using various forms of welding, soldering, or brazing. In various embodiments, the techniques may include the use of electrodes and/or thermite. Example apparatuses using electrodes for welding are described with respect to FIG. 1 and FIG. 2. Example apparatuses using thermite are described with respect to FIG. 3 and FIG. 4. A set of various methods using such apparatuses to retrieve fish is described with respect to FIGS. 5 to 7.

The present techniques may derive one or more benefits. First, the techniques may improve the attachment strength between fishing tools and fish and thus improve retrieval success rates for metal fish. Additionally, the techniques enable the retrieval of metal fish regardless of their different shapes and sizes of fish. Thus, in some embodiments, the techniques herein remove the need for measuring objects for potential retrieval purposes before placing them downhole.

### Welding Based Fishing Apparatuses

FIG. 1 is a cross sectional view of an exemplary apparatus using an internally grounded welding device for retrieving objects from downhole in a well. In various embodiments, the apparatus 100 is a fishing tool. The apparatus 100 includes a spear 102 with an electrode 104A and an overshot 106. The apparatus 100 includes a second electrode 104B coupled to the overshot 106. The apparatus 100 includes a battery 108 with a negative terminal coupled to the first electrode 104A via a wire 110A and a positive terminal coupled to the second electrode 104B via a second wire 110B. The apparatus 100 includes a grapple 112 conductively coupled to the second electrode 104B. For example, the grapple 112 may be a metal parts with teeth that are used to bite into and thus latch onto an object. A fish 114 is shown bonded to the apparatus 100 via a weld 116 with the grapple 112.

In one embodiment, by using a battery 108 or other source of power, the grapple 112 can be modified to send electricity through the spear 102 of the apparatus 100 to the fish 114 causing metal to fuse or weld to the fishing tool. The apparatus may thus not rely on the grapple 112 alone to engage the fish 114. In various embodiments, the apparatus 100 could be deployed using pipe, coiled tubing, or wireline. Moreover, in various embodiments, different heads can be made for the apparatus 100 to engage different types of fish 114 with different shaped electrodes 104A and 104B.

In various embodiments, the apparatus 100 is bonded to the fish 114 using resistance spot welding. Resistance spot welding uses current and pressure to fuse two pieces of metal together with no added flux or filler material. Electrical current is passed through the electrodes 104A and 104B and the metals to be welded in the grapple 112 and the fish 114 causing these base metals to melt and fuse together thus forming weld 116.

As one example, the fish 114 may be a pipe. For example, the pipe may be damaged and thus not respond well to being lifted out using spears or grapples. The apparatus 100 can thus be lowered onto the top of the pipe such that the spear 102 is inserted into the opening of the pipe and the overshot 106 covers the outside of the pipe.

FIG. 2 is a cross sectional view of an exemplary apparatus using a well-grounded welding device for retrieving objects from downhole in a well. FIG. 2 includes similarly referenced elements from FIG. 1. The apparatus 200 excludes the spear 102 of FIG. 1. The wire 110A from battery 108 is connected to any suitable ground circuit. In some examples, the ground circuit may ultimately be grounded to the ground, which may be the surface of the wellbore or any other ground contact.

### Exemplary Apparatuses Using Thermite

FIG. 3 is a cross sectional view of an exemplary apparatus using a thermite-based device with an overshot for retrieving objects from downhole in a well. The apparatus 300 of FIG. 3 includes similarly referenced elements from FIG. 1. In addition, the apparatus 300 includes a reservoir 302 holding a mixture of thermite and alloying metal. The apparatus 300 includes a release 304 for molten metal. In some embodiments, the release 304 may be fusible. The apparatus includes a diverter 306 for molten metal. In various embodiments, thermite soldering or brazing can be used to weld two metal surfaces together with molten metal. Thermite is mixed with an alloying metal in a reservoir and ignited. Molten metal flows out of the reservoir into a mold where it flows around the void between the two surfaces and bonds them together with a weld 308. In some embodiments, the apparatus 300 can be used to engage the fish via the grapple 112, ignite the thermite and alloying metal in the reservoir 302, and then release the molten metal via release 304 and divert the molten metal via diverter 306 into the gap between the grapple 112 and the fish 114 to bond the two together. The apparatus 300 can then be retrieved to the surface.

As one example, the fish 114 may be a damaged pipe. The apparatus 300 may be lowered onto the fish 114 until the top of the fish 114 is surrounded by the overshot 106. In some examples, the grapple 112 may then grip the fish 114. Once the overshot 106 is in place, the mixture in reservoir 302 may be ignited and the release 304 opened to allow molten metal to flow over the diverter 306 and between the fish 114 and grapple 112. In various examples, the molten metal may be allowed to cool and the apparatus 300 is then retrieved along with the fish 114. In this manner, the fish 114 can be retrieved without the use of any power source.

FIG. 4 is a cross sectional view of an exemplary apparatus using a thermite-based device with a spear for retrieving objects from downhole in a well. FIG. 4 includes similarly referenced elements from FIG. 1 and FIG. 3. In contrast with FIG. 3, the apparatus 400 includes a spear 102 instead of a grapple. The spear 102 is coupled to the reservoir 302 via the release 304. The spear 102 is further shown including a number of holes that enable the molten metal to flow to the space between the spear 102 and the inner surface of the fish 114 to form a weld 308. For example, the weld 308 may include a mixture of the molten metal, the fish 114, and the spear 102.

As one example, the fish 114 may again be a broken pipe. In this example, the apparatus 400 can be lowered into the wellbore until the spear 102 reaches inside the opening of the fish 114. The mixture in the reservoir 302 can then be ignited and the release 304 opened to allow the resulting molten metal mixture to flow into the space between the fish 114 and the spear 102 and form the weld 308. In various examples, a charge can be activated to ignite the mixture in the reservoir 302. For example, in various embodiments, an explosive charge can be activated mechanically or hydraulically. A mechanical activation may include the striking of two objects together. For example, the mechanical activation may be executed using a drop bar. In this example, a bar is dropped down the work string and strikes a mechanical firing mechanism that starts the ignition of the prime explosive. A hydraulic activation may include the raising of pressure downhole via dropping a ball that seals on a profile in the tool. The application of this pressure initiates the firing head, which ignites the prime explosive. The apparatus 400 is then retrieved from the well with the fish 114.

### Exemplary Methods for Implementing the Present Techniques

FIG. 5 is a process flow diagram of an exemplary method for retrieving a fish from a wellbore using welding. The method may start at block 502, where a weld-based fishing tool is lowered into a well. For example, the weld-based fishing tool may be lowered into the wellbore of a well. In various examples, the wellbore may have a length of any number of miles or kilometers.

At block 504, welding is initiated to bond the weld-based fishing tool with a fish. For example, the welding may be initiated in response to detecting a target pressure or a predetermined amount of time. In some examples, the target pressure may be sensed using a sensor attached to the weld-based fishing tool. In various examples, the welding may be initiated by applying an electrical current through one or more electrodes coupled to grapples in contact with the fish. In some examples, the welding may be initiated using thermite. For example, a charge may be initiated that causes a reaction of the termite with an alloying metal that flows to form the bond between the retrieval attachment and the fish.

At block 506, the weld-based fishing tool is raised from the well to retrieve the fish from the well. For example, the weld-based fishing tool may be retrieved by pipe or wireline. In some examples, the weld-based fishing tool may be deployed on a wireline or a pipe, and then retrieved using the same wireline or pipe. In various examples, the fish is baited on a wireline with a fishing neck and then a pipe may be used to engage the fishing neck to retrieve the fish.

At block 508, the fish is removed from the weld-based fishing tool. For example, the fish may be decoupled from the weld-based fishing tool using any suitable means, such as by cutting, applying heat, bending, or otherwise applying force at the welding site, etc. Those skilled in the art will appreciate that the exemplary method 500 of FIG. 5 is

susceptible to modification without altering the technical effect provided by the present techniques. In practice, the exact manner in which the method 500 is implemented will depend, at least in part, on the details of the specific implementation. For example, in some embodiments, some of the blocks shown in FIG. 5 may be altered or omitted from the method 500 and/or new blocks may be added to the method 500.

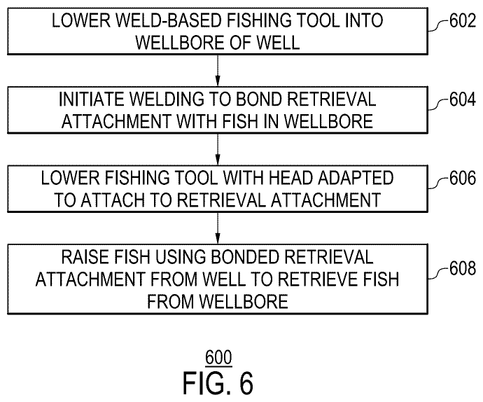

FIG. 6 is a process flow diagram of an exemplary method for retrieving a fish from a wellbore using a welded retrieval attachment. The method may start at block 602, where a welding-based fishing tool is lowered into a well. For example, the welding-based fishing tool may be lowered into the wellbore of a well that may be any number of miles or kilometers in depth. At block 604, welding is initiated to bond a retrieval attachment with the fish in the well.

In some embodiments, the retrieval attachment may be adapted to fit a particular fishing tool. In various embodiments, the welding may be initiated by applying an electrical current through one or more electrodes coupled to grapples in contact with the fish. In some examples, the welding may be initiated using thermite. For example, a charge may be initiated that causes a reaction of the termite with an alloying metal that flows to form the bond between the retrieval attachment and the fish.

At block 606, a fishing tool with a head adapted to the retrieval attachment is lowered into the well. For example, the head may have been adapted in advance to be able to securely couple with the retrieval attachment. In some embodiments, the head may be a head with which the retrieval attachment is adapted to securely attach. In some examples, the head may be a fishing neck. For example, the fishing neck may have an internal profile or an external profile.

At block 608, the fish is raised from the well using the bonded retrieval attachment to retrieve the fish from the well. For example, the weld-based fishing tool may be raised using a pipe or a wireline.

Those skilled in the art will appreciate that the exemplary method 600 of FIG. 6 is susceptible to modification without altering the technical effect provided by the present techniques. In practice, the exact manner in which the method 600 is implemented will depend, at least in part, on the details of the specific implementation. For example, in some embodiments, some of the blocks shown in FIG. 6 may be altered or omitted from the method 600 and/or new blocks may be added to the method 600.

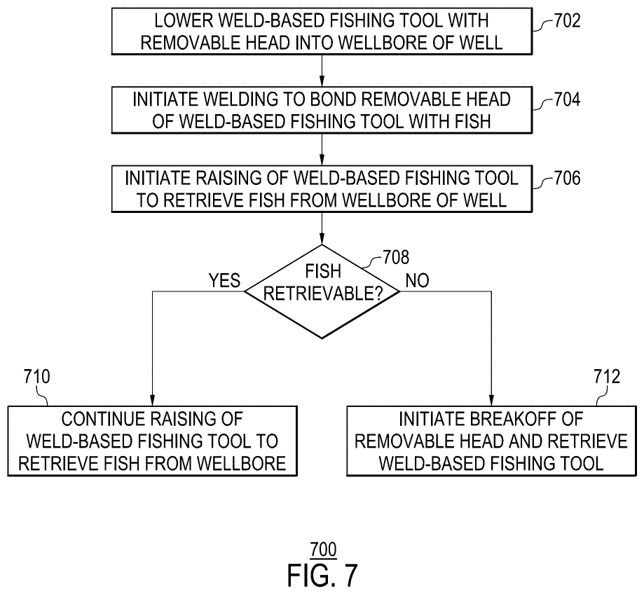

FIG. 7 is a process flow diagram of an exemplary method for retrieving a fish from a wellbore using a welded retrieval attachment. The method may start at block 702, where a weld-based fishing tool with a removable head is lowered into a well.

At block 704, welding is initiated to bond removable head of weld-based fishing tool with a fish in the well. For example, the welding may be initiated in response to detecting target pressure or a predetermined amount of time. For example, the firing head or a wireline signal can initiate a welding process and thus start a timer.

At block 706, raising of the weld-based fishing tool is initiated to retrieve the fish from the well. For example, the weld-based fishing tool may be raised using a pipe or a wireline.

At decision diamond 708, a determination is made as to whether the fish is retrievable. If the fish is detected as retrievable, then the method may continue at block 710. If the fish is determined to be not retrievable, then the method may continue at block 712. For example, the fish may be detected as being stuck in response to no movement after a threshold amount of force has been applied to lift the fish.

At block 710, raising of the weld-based fishing tool is continued to retrieve the fish from the well. For example, the weld-based fishing tool may be raised using a pipe or a wireline.

At block 712, a breakoff of the removable head is initiated, and the weld-based fishing tool retrieved. For example, the removable head may be decoupled from the weld-based fishing tool and left bonded to the fish. In some embodiments, the decoupling may be achieved using a device that runs above the overshot of the fishing tool. The weld-based fishing tool may then be retrieved to the surface.

Those skilled in the art will appreciate that the exemplary method 700 of FIG. 7 is susceptible to modification without altering the technical effect provided by the present techniques. In practice, the exact manner in which the method 700 is implemented will depend, at least in part, on the details of the specific implementation. For example, in some embodiments, some of the blocks shown in FIG. 7 may be altered or omitted from the method 700 and/or new blocks may be added to the method 700.

In this manner, the techniques described herein provide a practical application that directly improves the efficiency and success of metal object retrieval in wellbores. The techniques further enable detachment of the fishing tool in the case that such objects are not retrievable from a particular wellbore.

It is intended that the foregoing detailed description be understood as an illustration of selected forms that the invention can take and not as a definition of the invention. It is only the following claims, including all equivalents which are intended to define the scope of the claimed invention. Further, it should be noted that any aspect of any of the preferred embodiments described herein may be used alone or in combination with one another.

In one or more embodiments, the present techniques may be susceptible to various modifications and alternative forms, such as the following embodiments as noted in paragraphs 1 to 23:
1. An apparatus that includes a fishing tool including a metal welding surface. The apparatus also includes an electrode coupled to the metal welding surface and a power source.
2. The apparatus of paragraph 1, where the metal welding surface includes a grapple coupled to the inside of an overshot of the fishing tool.
3. The apparatus of paragraphs 1 or 2, including a spear, where the spear includes a second electrode coupled to a terminal of the power source.
4. The apparatus of paragraph 3, wherein the spear is surrounded by the metal welding surface.
5. The apparatus of any of paragraphs 1 to 4, where a first terminal of the power source is connected to the electrode and a second terminal of the power source is conductively coupled to a second electrode of the apparatus. The second electrode is to be inserted into an object to be retrieved.
6. The apparatus of any of paragraphs 1 to 5, where a first terminal of the power source is connected to the electrode and a second terminal of the power source is conductively coupled to the wellbore.
7. The apparatus of any of paragraphs 1 to 6, where the power source includes a battery in the apparatus.
8. The apparatus of any of paragraphs 1 to 7, where the power source includes a power line.
9. The apparatus of any of paragraphs 1 to 8, including a second electrode coupled to a spear.
10. An apparatus including a fishing tool including a metal welding surface. The apparatus also includes a reservoir containing a mixture of thermite and alloying metal. The apparatus further includes a welding surface coupled to the apparatus to receive molten metal from the reservoir.
11. The apparatus of paragraph 10, including a diverter for molten metal.
12. The apparatus of paragraphs 10 or 11, including a release for molten metal.
13. The apparatus of any of paragraphs 10 to 12, where the welding surface includes a grapple coupled to an overshot of the fishing tool.
14. The apparatus of any of paragraphs 10 to 13, where the welding surface includes a surface of a spear, wherein the spear is configured to receive and dispense molten metal from the reservoir.
15. A method of retrieving objects from wellbores. The method includes lowering a weld-based fishing tool into a wellbore of a well. The method includes initiating a welding to bond the weld-based fishing tool with a fish. The method includes raising the weld-based fishing tool from the wellbore to retrieve the fish.
16. The method of paragraph 15, where the welding is initiated in response to detecting a pressure exceeds a threshold.
17. The method of paragraphs 15 or 16, where the welding is initiated in response to detecting a predetermined amount of time has passed.
18. The method of any of paragraphs 15 to 17, where initiating the welding includes activating a switch to enable a resistance spot welding between the fish and a welding surface of the weld-based fishing tool.
19. The method of any of paragraphs 15 to 18, where initiating the welding includes igniting a mixture of thermite and alloying metal.
20. The method of any of paragraphs 15 to 19, including engaging the fish using a spear or grapple prior to initiating the welding.
21. The method of any of paragraphs 15 to 20, where initiating the welding includes initiating a welding to bond a retrieval attachment with the fish and lowering a fishing tool with a head adapted to attach to the retrieval attachment.
22. The method of any of paragraphs 15 to 21, where the weld-based fishing tool includes a removable head, including initiating a breakoff of the removable head in response to detecting that the fish is not retrievable.
23. The method of any of paragraphs 15 to 22, including removing the fish from the weld-based fishing tool.

While the embodiments described herein are well-calculated to achieve the advantages set forth, it will be appreciated that such embodiments are susceptible to modification, variation, and change without departing from the spirit thereof. In other words, the particular embodiments described herein are illustrative only, as the teachings of the present techniques may be modified and practiced in different but equivalent manners apparent to those skilled in the art having the benefit of the teachings herein. Moreover, the systems and methods illustratively disclosed herein may suitably be practiced in the absence of any element that is not specifically disclosed herein and/or any optional element disclosed herein. While compositions and methods are described in terms of “comprising” or “including” various components or steps, the compositions and methods can also “consist essentially of” or “consist of” the various components and steps. Indeed, the present techniques include all alternatives, modifications, and equivalents falling within the true spirit and scope of the appended claims. Many alterations, modifications, and variations will be apparent to those skilled in the art in light of the foregoing description without departing from the spirit or scope of the present disclosure and that when numerical lower limits and numerical upper limits are listed herein, ranges from any lower limit to any upper limit are contemplated.

What is claimed is:

1. An apparatus, comprising:
a fishing tool comprising a metal welding surface; and
an electrode coupled to the metal welding surface and a power source.

2. The apparatus of claim 1, wherein the metal welding surface comprises a grapple coupled to the inside of an overshot of the fishing tool.

3. The apparatus of claim 1, comprising a spear, wherein the spear comprises a second electrode coupled to a terminal of the power source.

4. The apparatus of claim 3, wherein the spear is surrounded by the metal welding surface.

5. The apparatus of claim 1, wherein a first terminal of the power source is connected to the electrode and a second terminal of the power source is conductively coupled to a second electrode of the apparatus, wherein the second electrode is to be inserted into an object to be retrieved.

6. The apparatus of claim 1, wherein a first terminal of the power source is connected to the electrode and a second terminal of the power source is conductively coupled to a wellbore.

7. The apparatus of claim 1, wherein the power source comprises a battery in the apparatus.

8. The apparatus of claim 1, wherein the power source comprises a power line.

9. The apparatus of claim 1, comprising a second electrode coupled to a spear.

10. An apparatus, comprising:
a fishing tool comprising a metal welding surface;
a reservoir containing a mixture of thermite and alloying metal; and
a welding surface coupled to the apparatus to receive molten metal from the reservoir.

11. The apparatus of claim 10, comprising a diverter for molten metal.

12. The apparatus of claim 10, comprising a release for molten metal.

13. The apparatus of claim 10, wherein the welding surface comprises a grapple coupled to an overshot of the fishing tool.

14. The apparatus of claim 10, wherein the welding surface comprises a surface of a spear, wherein the spear is configured to receive and dispense molten metal from the reservoir.

15. A method of retrieving objects from wellbores, comprising:
lowering a weld-based fishing tool into a wellbore of a well;
initiating a welding to bond the weld-based fishing tool with a fish; and
raising the weld-based fishing tool from the wellbore to retrieve the fish.

16. The method of claim 15, wherein the welding is initiated in response to detecting a pressure exceeds a threshold.

17. The method of claim 15, wherein the welding is initiated in response to detecting a predetermined amount of time has passed.

18. The method of claim 15, wherein initiating the welding comprises activating a switch to enable a resistance spot welding between the fish and a welding surface of the weld-based fishing tool.

19. The method of claim 15, wherein initiating the welding comprises igniting a mixture of thermite and alloying metal.

20. The method of claim 15, comprising engaging the fish using a spear or grapple prior to initiating the welding.

21. The method of claim 15, wherein initiating the welding comprises initiating a welding to bond a retrieval attachment with the fish and lowering a fishing tool with a head adapted to attach to the retrieval attachment.

22. The method of claim 15, wherein the weld-based fishing tool comprises a removable head, comprising initiating a breakoff of the removable head in response to detecting that the fish is not retrievable.

23. The method of claim 15, comprising removing the fish from the weld-based fishing tool.
